(19) United States
(12) Patent Application Publication
(10) Pub. No.: US 2014/0145500 A1
(43) Pub. Date: May 29, 2014

(54) POWER DISTRIBUTION DEVICE AND METHOD FOR FUEL CELL-SUPERCAPACITOR HYBRID VEHICLE

(71) Applicants: Sang Uk Kwon, Gyeonggi-do (KR); Sun Soon Park, Gyeonggi-do (KR); Kyu Il Lee, Gyeonggi-do (KR); Seo Ho Choi, Seoul (KR); Soon Il Jeon, Gyeonggi-do (KR); Soon Woo Kwon, Gyeonggi-do (KR)

(72) Inventors: Sang Uk Kwon, Gyeonggi-do (KR); Sun Soon Park, Gyeonggi-do (KR); Kyu Il Lee, Gyeonggi-do (KR); Seo Ho Choi, Seoul (KR); Soon Il Jeon, Gyeonggi-do (KR); Soon Woo Kwon, Gyeonggi-do (KR)

(73) Assignee: HYUNDAI MOTOR COMPANY, Seoul (KR)

(21) Appl. No.: 12/576,541

(22) Filed: Oct. 9, 2009

(30) Foreign Application Priority Data
Jun. 23, 2009 (KR) 10-2009-0055815

(51) Int. Cl. B60R 16/033

(52) U.S. Cl. CPC B60R 16/033
USPC 307/9.1

(57) ABSTRACT

The present invention provides a power distribution device and method for a fuel cell-supercapacitor hybrid vehicle, which can prevent an initial discharge of a supercapacitor during acceleration of the fuel cell-supercapacitor hybrid vehicle and, at the same time, enable the supercapacitor to provide power assist during high speed and high power operation. The power distribution device includes a relay mounted on a charge/discharge line between a fuel cell and a supercapacitor, a unidirectional buck converter disposed between an output terminal of the supercapacitor and a bus terminal of the fuel cell and outputting supercapacitor energy to the bus terminal of the fuel cell only when power assist is required, and a control means controlling the operation of the relay and the unidirectional buck converter.

### CROSS-REFERENCE TO RELATED APPLICATION

This application claims under 35 U.S.C. §119(a) the benefit of Korean Patent Application No. 10-2009-0055815 filed Jun. 23, 2009, the entire contents of which are incorporated herein by reference.

### BACKGROUND

(a) Technical Field

The present disclosure relates to a device and a method for power distribution for use in a fuel cell-supercapacitor hybrid vehicle. More particularly, it relates to a power distribution device and method for a fuel cell-supercapacitor hybrid vehicle, which can prevent an initial discharge of a supercapacitor during acceleration of the fuel cell-supercapacitor hybrid vehicle and enable the supercapacitor to provide power assist during high speed and high power operation.

(b) Background Art

A typical fuel cell system comprises a fuel cell stack for generating electrical energy by an electrochemical reaction, a hydrogen supply system for supplying hydrogen as a fuel to the fuel cell stack, an oxygen (air) supply system for supplying oxygen containing air as an oxidant required for the electrochemical reaction in the fuel cell stack, a thermal management system (TMS) for removing reaction heat from the fuel cell stack to the outside of the fuel cell system, controlling operation temperature of the fuel cell stack, and performing water management function, and a system controller for controlling overall operation of the fuel cell system. The fuel cell system generates heat and water as well as electricity.

Hydrogen supplied to an anode (“fuel electrode”) of the fuel cell stack is dissociated into hydrogen ions and electrons by a catalyst of the anode, and the dissociated hydrogen ions are transmitted to a cathode (“air electrode” or “oxygen electrode”) through an electrolyte membrane. Subsequently, oxygen supplied to the cathode reacts with the electrons migrating to the cathode through an external conducting wire to produce water, thus generates electrical energy.

The operation of the oxygen (air) supply system will now be described briefly. As shown in FIG. 15, dry air supplied from the outside through an air blower 202 is humidified by a humidifier 204 and supplied to a cathode of a fuel cell stack 100. Humid air after a reaction is supplied to the humidifier 204 through an outlet of the fuel cell stack 100 and used for the humidification.

The operation of the hydrogen supply system will now be described briefly. As shown in FIG. 15, hydrogen is supplied to an anode of the fuel cell stack 100 through two hydrogen supply lines. Through the first hydrogen supply line, hydrogen is supplied via a low pressure regulator (LPR) 302 to the anode, and a portion of hydrogen at an anode outlet of the fuel cell stack 100 is recirculated through a hydrogen recirculation blower 304.

Through the second hydrogen supply line, high pressure hydrogen is directly supplied to the anode through a valve control, and a portion of hydrogen is recirculated through an ejector 306.

In order to reduce the amount of hydrogen crossing over from the anode to the cathode during the hydrogen supply, the anode pressure should be reduced during low power operation. On the contrary, to increase the output power of the fuel cell stack, the anode pressure should be increased. Therefore, the LPR 302 is solely used when low pressure is required, and high pressure hydrogen is supplied through the valve control when high pressure is required or during purging.

In a fuel cell vehicle equipped with the fuel cell system having the above-described configuration and operation principle, a supercapacitor, an electrical energy storage means, is also used as an auxiliary power source for driving a motor.

In general, in a fuel cell-supercapacitor hybrid vehicle, in which a fuel cell and a supercapacitor are directly connected to each other, a high voltage DC-DC converter, a power conversion device, is located between the fuel cell and the supercapacitor to reduce the difference in voltage between the fuel cell and the supercapacitor and perform supercapacitor charge/discharge control and fuel cell power control.

For example, U.S. Pat. No. 6,484,075 discloses an idle control device for a fuel cell vehicle, in which an idle state is determined based on a rotational rate of a drive motor, a brake operation state, a battery's state of charge (SOC), and an electric load of the fuel cell vehicle, and if the idle state is determined, the power supply is cut off by stopping the supply of reactant gases for power generation by the fuel cell, and the power supply is restarted by the fuel cell when the battery's SOC is less than a predetermined SOC. For this purpose, a DC-DC chopper is connected to an output terminal of the fuel cell, thus stopping the power generation of the fuel cell in the idle state.

U.S. Pat. No. 6,920,948 discloses a power supply system in which a fuel cell and a battery are connected in parallel. A DC-DC converter is connected to the battery and the output ratio of the fuel cell and the battery is adjusted to control the output of the battery.

In these conventional fuel cell-supercapacitor (battery) hybrid systems, a power conversion device is disposed between the fuel cell and the supercapacitor (or battery) and mounted to the output terminal of the fuel cell or battery to adjust the output ratio of the fuel cell and the battery, thus performing battery charge/discharge control or fuel cell power control.

On the contrary, there is provided a fuel cell-supercapacitor hybrid system in which a fuel cell and a supercapacitor are directly connected to each other and a power conversion device such as DC-DC converter and DC-DC chopper is not provided. This system has advantages in that the control reliability is high since the power assist by the supercapacitor and the charge of the supercapacitor by recovering regenerative braking energy are automatically implemented, and the fuel efficiency is excellent since the amount of regenerative braking energy is large and the supercapacitor's efficiency is high.

However, when high output is required such as during acceleration, the supercapacitor is automatically discharged to provide power assist and, since the power assist is completed during the initial acceleration, the supercapacitor is rapidly discharged. Moreover, during high speed and high power operation (e.g., during passing acceleration and high-speed acceleration), the supercapacitor cannot provide the power assist any longer, which is the limitation of the fuel cell-supercapacitor hybrid system.

That is, as can be seen from in the graph of FIG. 14 showing changes in current during full acceleration, the existing fuel cell-supercapacitor hybrid system has problems in that since the fuel cell voltage drops during full acceleration, the supercapacitor is initially discharged to assist the power, and thus the power of the fuel cell gradually drops; however, during high power operation, the supercapacitor energy is insufficient, and thus it is impossible to assist the power.

The above information disclosed in this Background section is only for enhancement of understanding of the background of the invention and therefore it may contain information that does not form the prior art that is already known in this country to a person of ordinary skill in the art.

### SUMMARY OF THE DISCLOSURE

The present invention provides power distribution devices and methods for a fuel cell-hybrid vehicle, which can stop the fuel cell power generation during idle stop and during regenerative braking, while preserving the advantages of a fuel cell-supercapacitor hybrid system. Moreover, the power distribution devices and methods can prevent an initial discharge of a supercapacitor to improve acceleration performance during acceleration by independently controlling power assist of the supercapacitor and enable the supercapacitor to provide power assist during high speed and high power operation.

In one aspect, the present invention provides a power distribution device for a hybrid vehicle including a fuel cell and a supercapacitor, the power distribution device including a relay mounted on a charge/discharge line between the fuel cell and the supercapacitor, a unidirectional buck converter disposed between an output terminal of the supercapacitor and a bus terminal of the fuel cell and outputting supercapacitor energy to the bus terminal of the fuel cell only when power assist is required, and a control means controlling the operation of the relay and the unidirectional buck converter.

In a preferred embodiment, the control means may include a power distribution controller receiving a brake on/off signal, an accelerator pedal signal, a bus terminal voltage, and a supercapacitor voltage and outputting a relay on/off command and a converter controller output command, and a converter controller controlling a duty ratio of the unidirectional buck converter based on the output command of from the power distribution controller.

In another preferred embodiment, the unidirectional buck converter may be a buck type converter operated under conditions where the supercapacitor voltage is high and the fuel cell voltage is low and having a capacity corresponding to the power required for the supercapacitor power assist.

In another aspect, the present invention provides a power distribution method for a hybrid vehicle including a fuel cell and a supercapacitor, wherein power distribution between the fuel cell and the supercapacitor is performed through driving modes including a normal hybrid mode, in which the vehicle is driven while the fuel cell and the supercapacitor are directly connected to each other by a relay between the fuel cell and the supercapacitor, a fuel cell only mode, in which electric power is supplied only from the fuel cell when the relay is turned off, a supercapacitor power assist mode, in which only supercapacitor energy is output through a unidirectional buck converter while the relay is being turned off when high power is required, and a fuel cell stop mode, in which power generation of the fuel cell is stopped and the required power is output only from the supercapacitor during low power operation of the fuel cell.

In a preferred embodiment, a transition from the normal hybrid mode to the fuel cell only mode may be performed in such a manner that, if it is determined that the fuel cell output power is higher than a predetermined level and that the supercapacitor is self-discharged while the fuel cell and the supercapacitor are directly connected to each other by the relay, the relay between the fuel cell and the supercapacitor is immediately turned off such that the discharge of the supercapacitor energy is stopped.

In another preferred embodiment, a transition from the fuel cell only mode to the supercapacitor power assist mode may be performed in such a manner that, if a time point at which the unidirectional buck converter is operated is reached as the fuel cell voltage drops in the fuel cell only mode, or if high power is required, a duty ratio of the unidirectional buck converter is controlled to provide the required power.

In still another preferred embodiment, the unidirectional buck converter may perform a duty control using a voltage difference between the fuel cell voltage (bus terminal voltage) and the supercapacitor voltage to provide the required power.

In yet another preferred embodiment, a transition from the supercapacitor power assist mode to the normal hybrid mode may be performed in such a manner that, if the fuel cell voltage and the supercapacitor voltage become equal to each other, a power assist current control of the unidirectional buck converter is stopped and, the fuel cell and the supercapacitor are directly connected to each other by the relay.

In still yet another preferred embodiment, a transition from the fuel cell only mode to the normal hybrid mode may be performed in such a manner that, if it is necessary to recover regenerative braking energy to the supercapacitor, the fuel cell and the supercapacitor are directly connected to each other again by the relay.

In a further preferred embodiment, when the vehicle request power is reduced in the supercapacitor power assist mode, the supercapacitor power assist mode may be switched to the normal hybrid mode.

In another further preferred embodiment, the fuel cell stop mode may be performed by stopping the supply of air to a cathode of a fuel cell stack or by stopping the supply of hydrogen to an anode of the fuel cell stack.

In still another further preferred embodiment, if it is determined that the vehicle request power is increased in the fuel cell stop mode or if it is determined that the supercapacitor voltage drops to a predetermined level corresponding to a time point at which the fuel cell power generation is restarted, the fuel cell power generation may be restarted such that the vehicle enters the normal hybrid mode.

Other aspects and preferred embodiments of the invention are discussed infra.

It is understood that the term “vehicle” or “vehicular” or other similar term as used herein is inclusive of motor vehicles in general such as passenger automobiles including sports utility vehicles (SUV), buses, trucks, various commercial vehicles, watercraft including a variety of boats and ships, aircraft, and the like, and includes hybrid vehicles, electric vehicles, plug-in hybrid electric vehicles, hydrogen-powered vehicles and other alternative fuel vehicles (e.g. fuels derived from resources other than petroleum). As referred to herein, a hybrid vehicle is a vehicle that has two or more sources of power, for example both gasoline-powered and electric-powered vehicles.

The above and other features of the invention are discussed infra.

### BRIEF DESCRIPTION OF THE DRAWINGS

The above and other features of the present invention will now be described in detail with reference to certain exemplary embodiments thereof illustrated the accompanying drawings which are given hereinbelow by way of illustration only, and thus are not limitative of the present invention, and wherein:

FIG. 1 is a configuration diagram showing a power distribution device for a fuel cell-supercapacitor hybrid vehicle in accordance with the present invention;

FIG. 2 is a graph showing changes in current of a fuel cell, a supercapacitor, and an inverter during full acceleration when a power distribution method for a fuel cell-supercapacitor hybrid vehicle in accordance with the present invention is applied;

FIG. 3 is a graph showing changes in voltage of the fuel cell and the supercapacitor when a power distribution method for the fuel cell-supercapacitor hybrid vehicle in accordance with the present invention is applied;

FIG. 4 is a graph showing changes in voltage and current of the fuel cell when a power distribution method for the fuel cell-supercapacitor hybrid vehicle in accordance with the present invention is applied;

FIG. 5 is a block diagram illustrating driving modes of a fuel cell-supercapacitor hybrid vehicle in accordance with the present invention and transitions to the respective driving modes;

FIG. 6 is a flowchart illustrating a transition from a normal hybrid mode to a fuel cell only mode in the power distribution of a fuel cell-supercapacitor hybrid vehicle in accordance with the present invention;

FIG. 7 is a flowchart illustrating a transition from the fuel cell only mode to a supercapacitor power assist mode in the power distribution of the fuel cell-supercapacitor hybrid vehicle in accordance with the present invention;

FIG. 8 is a flowchart illustrating a transition from the supercapacitor power assist mode to the normal hybrid mode in the power distribution of the fuel cell-supercapacitor hybrid vehicle in accordance with the present invention;

FIG. 9 is a flowchart illustrating a process of reentering the normal hybrid mode during regenerative braking or power reduction in the power distribution of the fuel cell-supercapacitor hybrid vehicle in accordance with the present invention;

FIG. 10 is a flowchart illustrating a transition from the normal hybrid mode to a fuel cell stop mode in the power distribution of the fuel cell-supercapacitor hybrid vehicle in accordance with the present invention;

FIG. 11 is a flowchart illustrating a transition from the fuel cell stop mode to the normal hybrid mode in the power distribution of the fuel cell-supercapacitor hybrid vehicle in accordance with the present invention;

FIG. 12 is a graph showing changes in voltage of the supercapacitor and the fuel cell according to various driving modes in the power distribution of the fuel cell-supercapacitor hybrid vehicle in accordance with the present invention;

FIG. 13 is a graph showing a change in output power of the fuel cell according to various driving modes in the power distribution of the fuel cell-supercapacitor hybrid vehicle in accordance with the present invention;

FIG. 14 is a graph showing changes in current of a fuel cell, a supercapacitor, and an inverter during full acceleration in an existing fuel cell-supercapacitor hybrid system; and

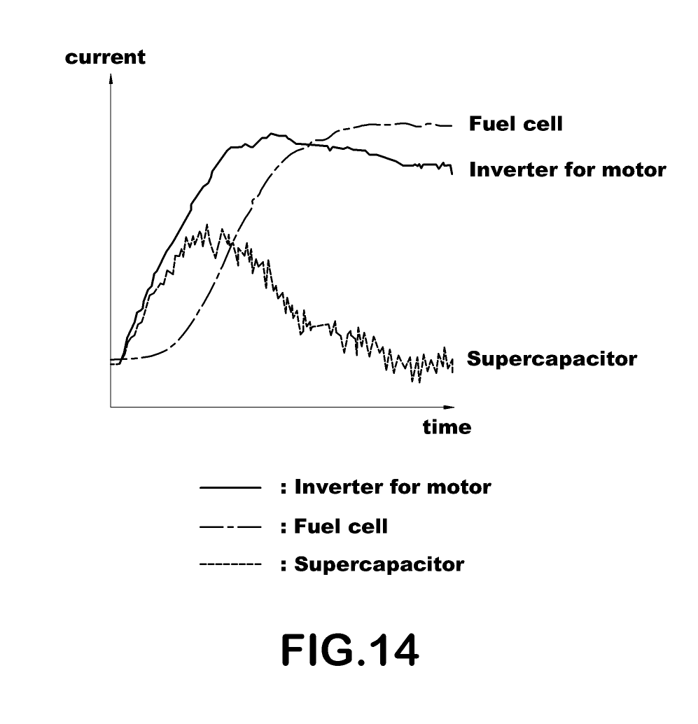

FIG. 15 is a configuration diagram illustrating the operation principle of a fuel cell system.

Reference numerals set forth in the Drawings includes reference to the following elements as further discussed below:

| | |
|---|---|
| 10: fuel cell | 20: supercapacitor |
| 30: unidirectional buck converter | 40: relay |
| 50: power distribution controller | 60: converter controller |
| 70: motor | 80: inverter |

It should be understood that the appended drawings are not necessarily to scale, presenting a somewhat simplified representation of various preferred features illustrative of the basic principles of the invention. The specific design features of the present invention as disclosed herein, including, for example, specific dimensions, orientations, locations, and shapes will be determined in part by the particular intended application and use environment.

In the figures, reference numbers refer to the same or equivalent parts of the present invention throughout the several figures of the drawing.

### DETAILED DESCRIPTION

Hereinafter reference will now be made in detail to various embodiments of the present invention, examples of which are illustrated in the accompanying drawings and described below. While the invention will be described in conjunction with exemplary embodiments, it will be understood that present description is not intended to limit the invention to those exemplary embodiments. On the contrary, the invention is intended to cover not only the exemplary embodiments, but also various alternatives, modifications, equivalents and other embodiments, which may be included within the spirit and scope of the invention as defined by the appended claims.

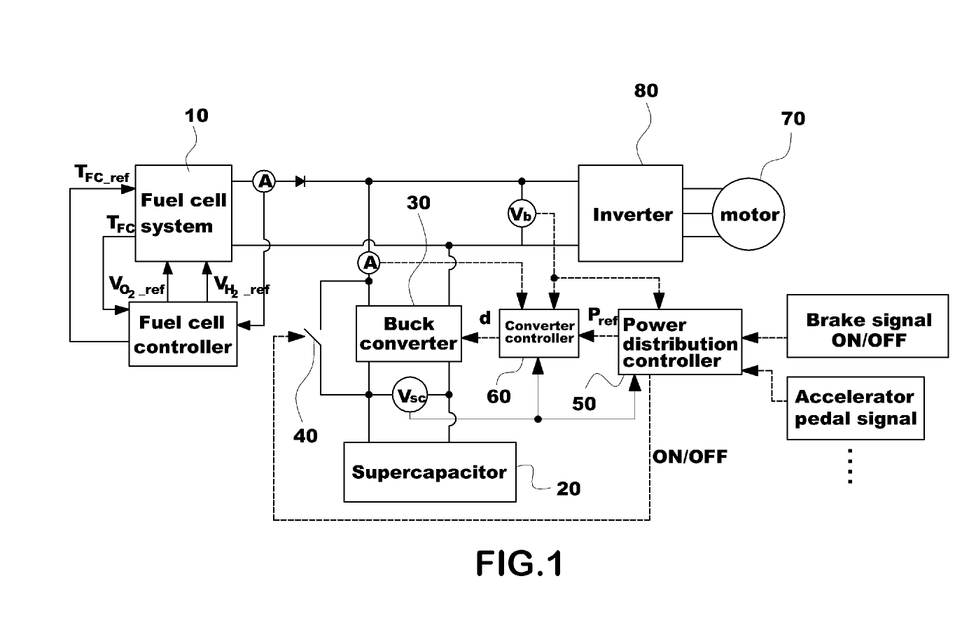

FIG. 1 is a configuration diagram showing a power distribution device for a hybrid vehicle including a fuel cell 10 and a supercapacitor 20 in accordance with an embodiment of the present invention.

The devices includes a unidirectional buck converter (fuel cell voltage<supercapacitor voltage) 30, a relay 40, and a controller for controlling the operation of the unidirectional buck converter 30 and the relay 40. The fuel cell 10 and the supercapacitor 20 can be directly connected to each other by the relay 40, thereby preventing an initial discharge of the supercapacitor 20 during acceleration and enabling the supercapacitor 20 to provide power assist during high-speed and high-power operation. The controller may include a power distribution controller 50 and a converter controller 60.

The relay 40 is installed on a charge/discharge line between the fuel cell 10, i.e., a bus terminal of the fuel cell 10, and the supercapacitor 20 so as to be able to directly connect or disconnect the fuel cell 10 and the supercapacitor 20.

The capacity of the unidirectional buck converter 30 is determined based on the power assist strategy of the supercapacitor 20. A unidirectional buck converter having a capacity corresponding to a required power may be adopted.

The power distribution controller 50 receives a brake on/off signal indicative of whether or not a brake is operated, a bus terminal voltage Vb and a supercapacitor voltage Vsc and outputs a relay on/off command and a converter controller output command Pref.

The converter controller 60 controls the unidirectional buck converter 30 to satisfy an output request command by adjusting the duty ratio D of the unidirectional buck converter 30 based on the output command of the power distribution controller 50.

The power distribution control of the fuel cell-supercapacitor hybrid vehicle in accordance with the present invention includes a normal hybrid mode in which the fuel cell 10 and the supercapacitor 20 are directly connected to each other by the relay 40, a fuel cell only mode in which a motor is driven only by the fuel cell 10 by turning off the relay 40, and a supercapacitor power assist mode in which the power assist is provided by the supercapacitor 20 using the unidirectional buck converter 30 when high power is required.

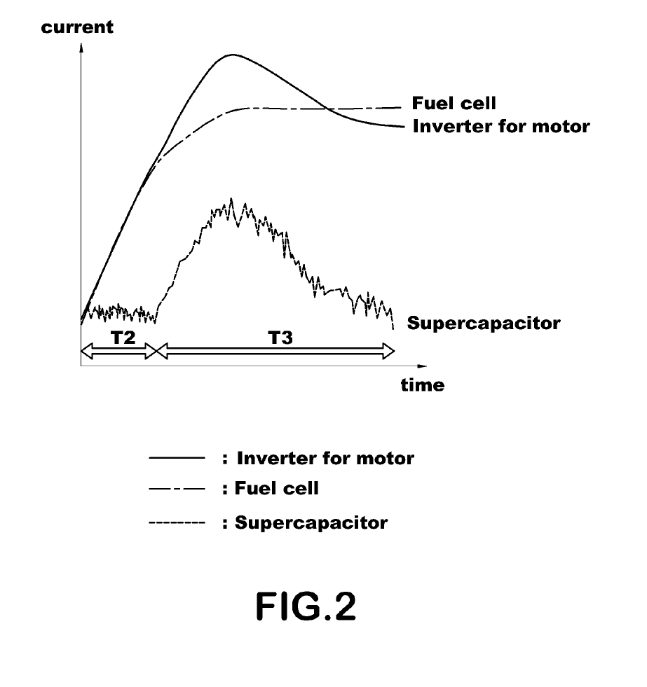

According to embodiments of the present invention, as shown in FIG. 2 showing the changes in current during full acceleration, the relay 40 connecting the fuel cell 10 and the supercapacitor 20 is turned off before entering the supercapacitor power assist mode such that the power is output only from the fuel cell 10, thus preventing an initial discharge of the supercapacitor. During high power operation, the unidirectional buck converter 30 is used such that the supercapacitor 20 can provide the power assist, thus increasing the magnitude and duration of output power required by the motor.

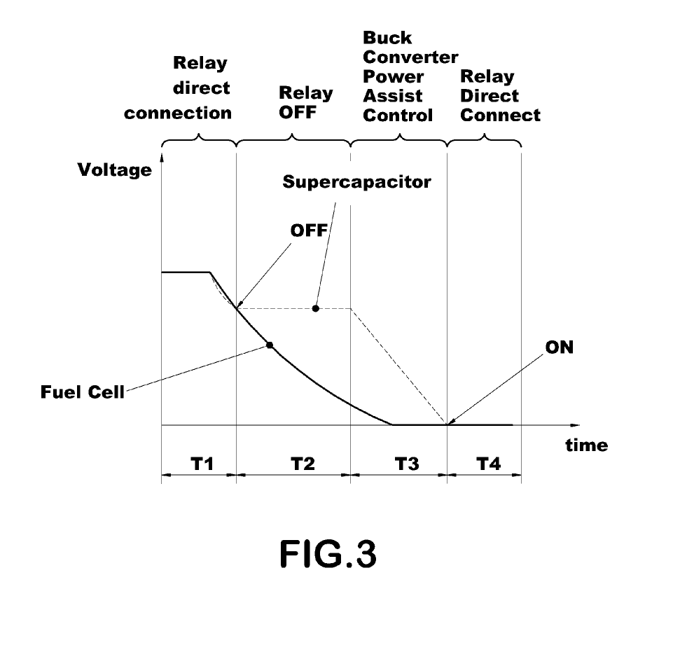

In more detail, as shown in FIG. 3 showing the changes in voltage during full acceleration, during high power operation such as full acceleration, the fuel cell 10 and the supercapacitor 20 are directly connected to each other by the relay, and thus the fuel cell voltage and the supercapacitor voltage are equally changed (Period T1 of FIG. 3). If the discharge amount of the supercapacitor 20 is greater than a predetermined value, the relay 40 is turned off such that the motor is driven only by the fuel cell 10. As a result, the supercapacitor voltage is maintained at a high level and the fuel cell (main bus terminal) voltage drops continuously (Period T2 of FIG. 3). Subsequently, if the dropping fuel cell voltage is more than a predetermined level, the output control of the unidirectional buck converter 30 is performed to control the supercapacitor power assist (Period T3 of FIG. 3). Then, if the fuel cell voltage, i.e., the main bus terminal voltage, and the supercapacitor voltage are equal to each other, the relay 40 is turned on to directly connect the fuel cell 10 and the supercapacitor 20 (Period T4 of FIG. 3).

In this case, the unidirectional buck converter 40 is a buck type converter operated under conditions where its input terminal voltage (supercapacitor voltage) is high and its output terminal voltage (fuel cell voltage) is low. When the input terminal voltage (supercapacitor voltage) and the output terminal voltage (fuel cell voltage) are equal to each other, the unidirectional buck converter 30 is not operated any longer. Preferably, a unidirectional buck converter designed to have a capacity corresponding to a required power is used as the unidirectional buck converter 40.

Power distribution methods for the fuel cell-supercapacitor hybrid vehicle in accordance with embodiments of the present invention will be described in more detail.

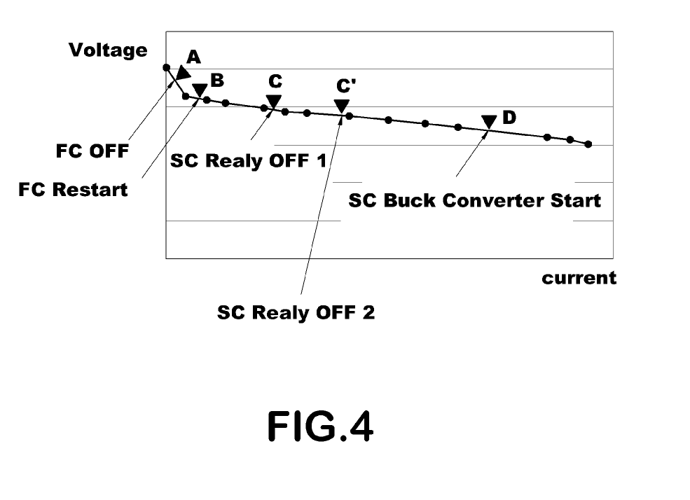

Referring to FIG. 4 shows the changes in voltage and current of the fuel cell, the control operations of the fuel cell 10 and the supercapacitor 20 performed in the respective modes will be described.

In FIG. 4, time point A is a time point at which the power generation of the fuel cell 10 is stopped (idle stop), and time point B is a time point at which the power generation of the fuel cell 10 is restarted.

Since the period from time point A to time point B corresponds to the low power period and the low efficiency period of the fuel cell system, idle stop control is conducted in which only the supercapacitor 20 drives the vehicle by stopping the power generation of the fuel cell 10. Also, during the period from time point A to time point B supercapacitor 20 is prevented from being automatically charged from the fuel cell by stopping the power generation of the fuel cell 10 and regenerative braking energy is supplied to the supercapacitor 20 as much as possible.

The fuel cell 10 is a power source in which the voltage drops and the output power increases when the current is increased. Time point C at which the relay 40 between the fuel cell 10 and the supercapacitor 20 is turned off and time point D at which the unidirectional buck converter 30 is operated can be determined based on the fuel cell voltage. Moreover, time points C and D can be determined based on the fuel cell output power, the motor output power, and the fuel cell current.

Time point C shown in FIG. 4, i.e., a time point at which the relay 40 between the fuel cell 10 and the supercapacitor 20 is turned off (OFF 1), is control variable C for determining how much and how long the supercapacitor energy should be stored. Time point D, i.e., a time point at which the power assist of the supercapacitor 20 should be started and the supercapacitor energy is actually required, is control variable D.

Time point C′ in FIG. 4 is a time point at which the relay 40 between the fuel cell 10 and the supercapacitor 20 is actually turned off and may exist in the period between time point C and time point D based on a time point at which the supercapacitor 20 is self-discharged. Moreover, time point C′ is a time point at which the relay 40 is turned off (OFF 2) when the acceleration is made once again after the relay 40 is turned on due to regenerative braking or power reduction.

Next, the power distribution methods in accordance with embodiments of the present invention will be described in more detail with respect to the normal hybrid mode, the fuel cell only mode, and the supercapacitor power assist mode.

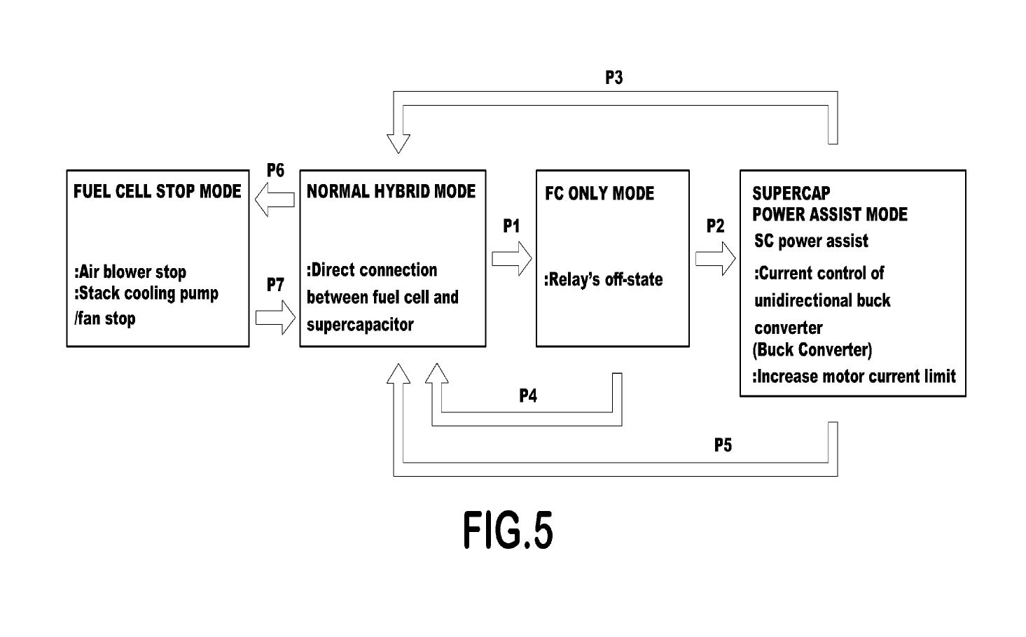

As shown in the block diagram of FIG. 5, the normal hybrid mode is a driving mode in which the vehicle is driven while the fuel cell 10 and the supercapacitor 20 are directly connected to each other, the fuel cell only mode is a driving mode in which the vehicle is driven only by the fuel cell 10 as the relay 40 between the fuel cell 10 and the supercapacitor 20 is turned off, and the supercapacitor power assist mode is a driving mode in which the supercapacitor power assist is performed by the power control of the unidirectional buck converter 30, thus improving acceleration performance by increasing the motor current limit as much as the supercapacitor power assist. The power distribution control with respect to the fuel cell 10 and the supercapacitor 20 is performed through transitions P1 to P7 to the respective driving modes, which will be described in detail below.

Transition from Normal Hybrid Mode to Fuel Cell Only Mode (P1)

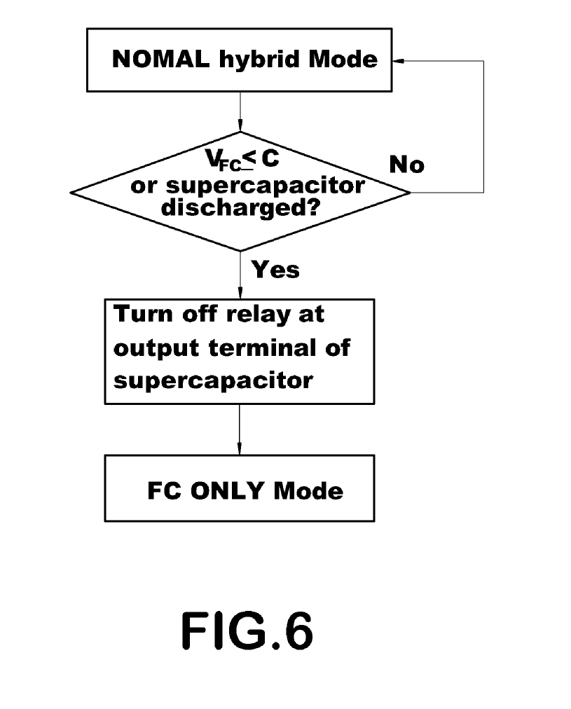

FIG. 6 is a flowchart illustrating a transition from the normal hybrid mode to the fuel cell only mode.

When it is determined that the vehicle is driven while the fuel cell 10 and the supercapacitor 20 are directly connected to each other by the relay 40, that the fuel cell output power is higher than a predetermined level, and that the supercapacitor 20 is self-discharged, the relay 40 between the fuel cell 10 and the supercapacitor 20 is turned off to prevent the supercapacitor 20 from being discharged and ensure the supercapacitor energy to be used when high power is required.

That is, the power distribution controller 50 receives a bus terminal voltage Vb and a supercapacitor voltage Vsc and turns off the relay 40 if it is determined that a fuel cell voltage V_{FC} drops until time point C at which the relay 40 between the fuel cell 10 and the supercapacitor 20 is turned off or that the supercapacitor 20 is self-discharged. As a result, the supercapacitor 20 is prevented from being discharged, and the vehicle enters the fuel cell only mode in which the motor 70 is driven only by the fuel cell.

Transition from Fuel Cell Only Mode to Supercapacitor Power Assist Mode (P2)

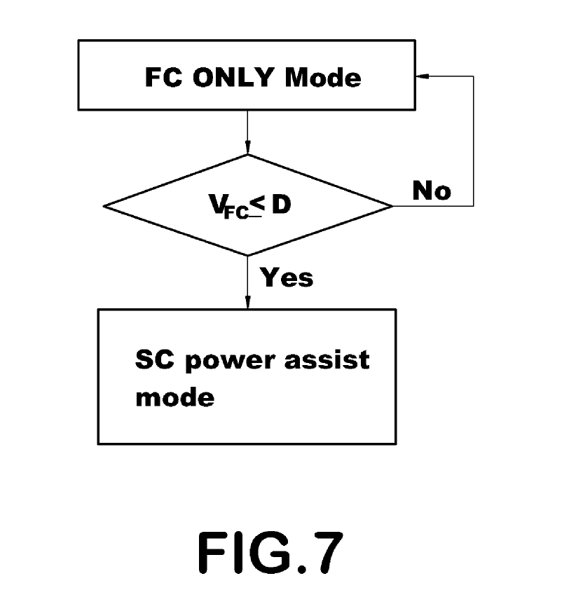

FIG. 7 is a flowchart illustrating a transition from the fuel cell only mode to the supercapacitor power assist mode.

When it is determined that the vehicle is driven in the fuel cell only mode and that the fuel cell output power is high, a supercapacitor power assist control is performed through the unidirectional buck converter 30.

That is, if the power distribution controller 50 receives a high speed/high power request signal, i.e., when the fuel cell voltage drops and time point D at which the unidirectional buck converter 30 is operated is reached or when an accelerator pedal is continuously pressed, the power distribution controller 50 outputs a converter controller output command Pref. Then, the converter controller 60 controls the unidirectional buck converter 30 to satisfy the request output command by adjusting the duty ratio d of the unidirectional buck converter 30 based on the output command Pref of the power distribution controller 50. Therefore, the supercapacitor energy is supplied to the motor 70 through the unidirectional buck converter 30 and the inverter 80, thus providing the power assist.

In this case, the magnitude of the output power assisted by the supercapacitor 20 may be determined based on required acceleration performance or motor characteristics. The unidirectional buck converter 30 performs a duty control using a voltage difference between both terminals (bus terminal voltage and the supercapacitor voltage), thus satisfying the required power.

As such, the relay 40 connecting the fuel cell 10 and the supercapacitor 20 is turned off before entering the supercapacitor power assist mode such that the power is output only from the fuel cell 10, thus preventing the initial discharge of the supercapacitor 20. During high power operation, the unidirectional buck converter 30 is used such that the supercapacitor 20 can provide the power assist, thus increasing the magnitude and duration of output power required by the motor.

Transition from Supercapacitor Power Assist Mode to Normal Hybrid Mode (P3)

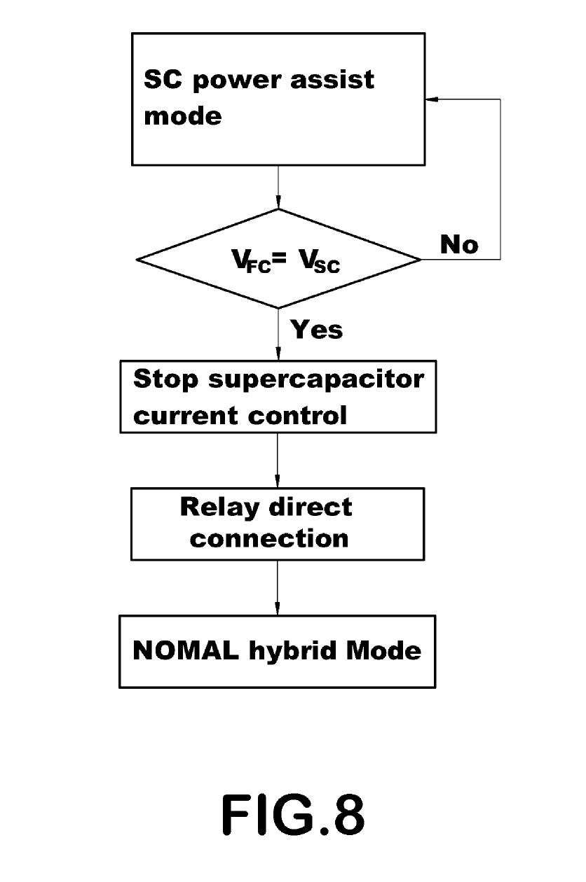

FIG. 8 is a flowchart illustrating a transition from the supercapacitor power assist mode to the normal hybrid mode.

In the supercapacitor power assist mode, if the power distribution controller 50 receives the bus terminal voltage Vb and the supercapacitor voltage Vsc and, if it is determined that the bus terminal voltage Vb corresponding to the fuel cell voltage V_{FC} and the supercapacitor voltage Vsc become equal to each other, the power assist current control of the unidirectional buck converter 30 is not performed, and the relay 40 is turned on such that the fuel cell 10 and the supercapacitor 20 are directly connected to each other, thus reentering the normal hybrid mode.

In this case, since all of the supercapacitor energy is consumed for the power assist control, the supercapacitor 20 does not provide the power assist any longer, and the motor current limit is limited to a maximum output power of the fuel cell 10.

Meanwhile, the transition processes P1 to P3 are necessary when high power is required. However, if the regenerative braking or power reduction is made by a driver's request (based on the operation amount and time of a brake pedal, the time at which an accelerator pedal is released, etc.) before the power assist of the supercapacitor 20, the relay 40 is turned off such that the fuel cell 10, i.e., the bus terminal, and the supercapacitor 20 are disconnected from each other, and thus the supercapacitor 20 cannot recover the regenerative braking energy, which makes it impossible to charge the supercapacitor.

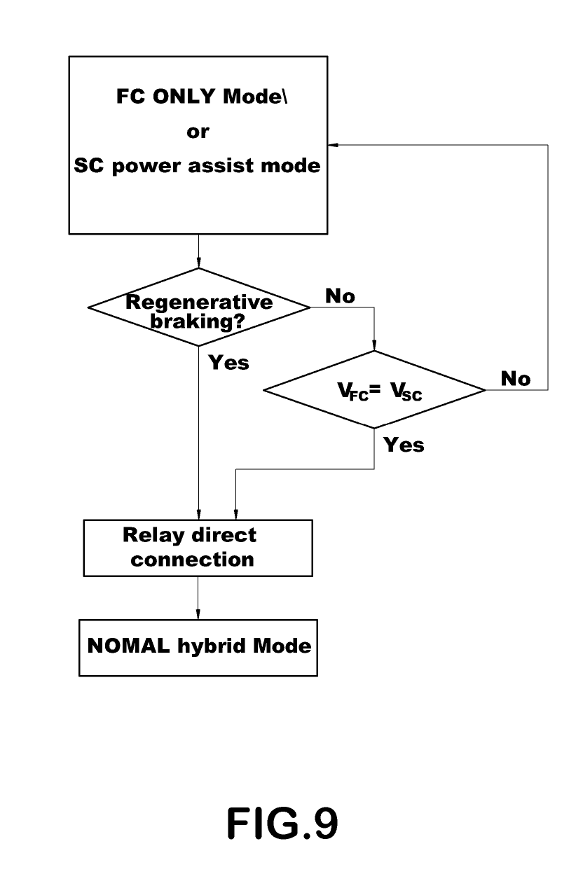

Therefore, the relay at the output terminal of the supercapacitor, i.e., the relay 40 between the fuel cell 10 and the supercapacitor 20 is immediately turned on during regenerative braking or power reduction such that the vehicle enters the normal hybrid mode in which the fuel cell 10 and the supercapacitor 20 are directly connected to each other, which will now be described with reference to the flowchart of FIG. 9 (transition processes P4 and P5).

Transition from Fuel Cell Only Mode to Normal Hybrid Mode (P4)

While the vehicle is driven in the fuel cell only mode or supercapacitor power assist mode, if a driver operates a brake pedal to reduce the vehicle speed, that is, when it is necessary to recover the regenerative braking energy, the relay at the output terminal of the supercapacitor, i.e., the relay 40 between the fuel cell 10 and the supercapacitor 20 is turned on such that the vehicle enters the normal hybrid mode in which the fuel cell 10 and the supercapacitor 20 are directly connected to each other. As a result, the regenerative braking energy is recovered and charged to the supercapacitor 20.

As such, since it is first necessary to recover the regenerative braking energy to the supercapacitor 20 during regenerative braking, the relay 40 between the fuel cell 10 and the supercapacitor 20 is immediately turned on such that the fuel cell 10 and the supercapacitor 20 are directly connected to each other and, as a result, the regenerative braking energy is charged to the supercapacitor 20.

Transition from Supercapacitor Power Assist Mode to Normal Hybrid Mode (P5)

When the vehicle request power is reduced (e.g., when the brake pedal is released) in the fuel cell only mode or supercapacitor power assist mode, the relay at the output terminal of the supercapacitor, i.e., the relay 40 between the fuel cell 10 and the supercapacitor 20 is not immediately turned on. Therefore, when the bus terminal voltage Vb is somewhat increased and equal to the supercapacitor voltage Vsc, the relay 40 is turned on such that the vehicle enters the normal hybrid mode in which the fuel cell 10 and the supercapacitor 20 are directly connected to each other.

As such, in the case where it is not the regenerative braking such as the case in which the request power is reduced, the relay 40 is turned on when the fuel cell voltage and the supercapacitor voltage are equal to each other such that the fuel cell 10 and the supercapacitor 20 are directly connected to each other, thus enabling the supercapacitor 20 to be charged from the fuel cell.

Meanwhile, in the power distribution methods for the fuel cell-supercapacitor hybrid vehicle in accordance with the present invention, the fuel cell power generation is stopped during low power operation of the fuel cell to avoid low efficiency operation, thus increasing fuel efficiency.

Especially, the reason that the fuel cell stop mode is necessary in the power distribution methods of the present invention is that the supercapacitor voltage is often maintained at a sufficiently high level for the supercapacitor power assist and the supercapacitor voltage can be maintained at a high level only with the regenerative braking energy. Therefore, the fuel cell stop mode during the low power period is necessary to prevent the supercapacitor from being charged by the fuel cell, which will now be described (transition process P6).

Transition from Normal Hybrid Mode to Fuel Cell Stop Mode (P6)

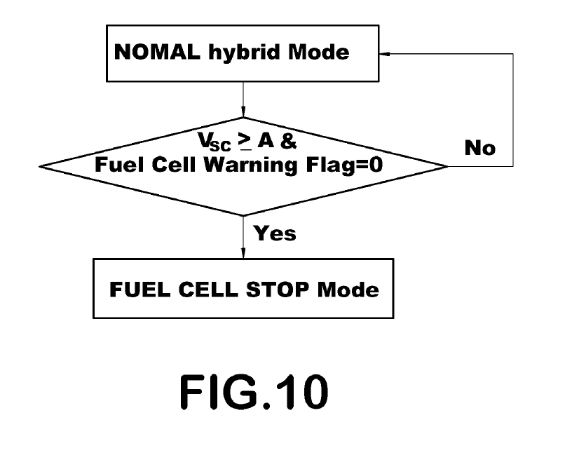

FIG. 10 is a flowchart illustrating a transition from the normal hybrid mode to the fuel cell stop mode.

If it is determined that the fuel cell output power is low, that the vehicle is driven while avoiding the low efficiency operation to increase fuel efficiency, and that the fuel cell is not in an abnormal state, the vehicle enters the fuel cell stop mode such as an idle stop mode, and the motor is driven only by the electric power supplied from the supercapacitor 20.

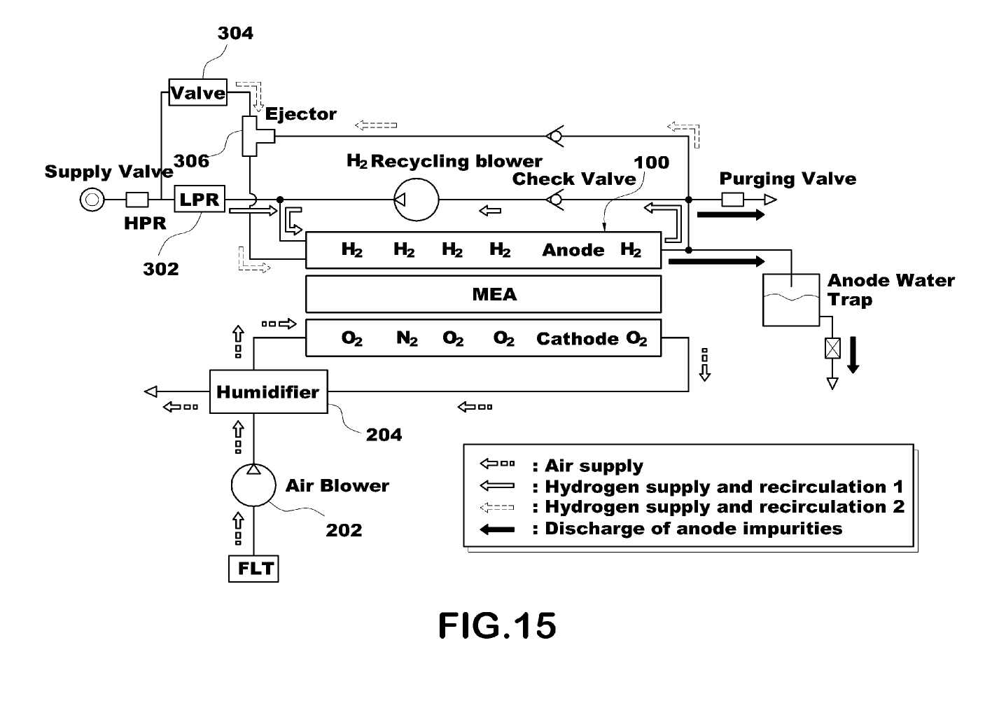

As can be seen from FIG. 15 showing the operation principle of the fuel cell system, the fuel cell power generation can be automatically stopped by stopping the supply of air to a cathode of the fuel cell stack to stop the power generation of the fuel cell stack.

At this time, the operation of the other B.O.P. components such as a cooling pump and a cooling fan is also stopped, and the supply of hydrogen may be further stopped if the deterioration of the fuel cell stack is not considered.

Transition from Fuel Cell Stop Mode to Normal Hybrid Mode (P7)

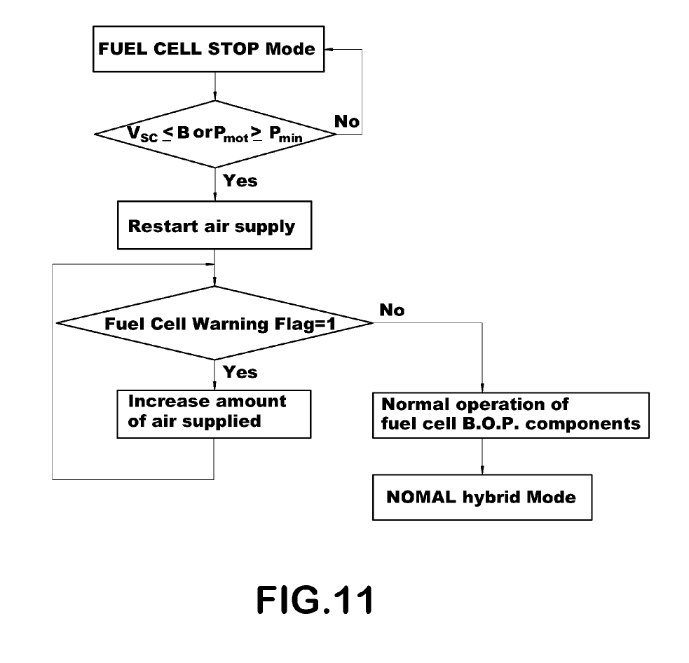

FIG. 11 is a flowchart illustrating a transition from the fuel cell stop mode to the normal hybrid mode.

If it is determined that the vehicle power Pmot is increased in the fuel cell stop mode or if the supercapacitor voltage Vsc used to drive the motor drops to a predetermined level corresponding to time point B, at which the fuel cell power generation is restarted, in the above transition process P6, the fuel cell power generation is restarted by supplying air to the cathode of the fuel cell stack such that the vehicle enters the normal hybrid mode. Moreover, if the fuel cell state is not restored to a normal state while the fuel cell power generation is restarted, the amount of air supplied is increased to accelerate the restoration of the fuel cell such that the operation of the other B.O.P. components is normally restarted.

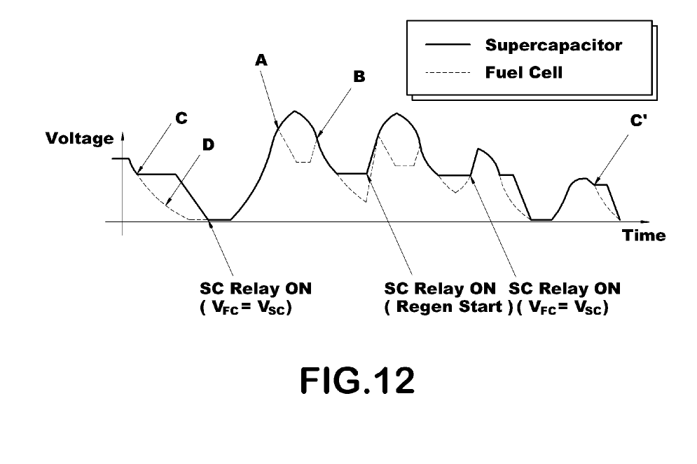

The above-described power distribution method for the fuel cell-supercapacitor hybrid vehicle will be summarized with respect to FIG. 12 below.

FIG. 12 is a graph showing changes in voltage of the supercapacitor and the fuel cell according to various driving modes in accordance with the present invention.

After the vehicle is driven while the fuel cell and the supercapacitor are directly connected to each other by the relay, the relay is turned off at time point C such that the vehicle enters the fuel cell only mode. Then, when the fuel cell voltage drops somewhat and high power is required, the vehicle enters the supercapacitor power assist mode at time point D. Subsequently, when the supercapacitor voltage and the fuel cell voltage become equal to each other, the relay is turned on to directly connect the fuel cell and the supercapacitor.

Moreover, if it is determined that time point A at which the fuel cell output power is reduced is reached, the vehicle enters the fuel cell stop mode. Then, if time point B is reached as the output power is increased, the fuel cell power generation is restarted such that the vehicle enters the normal hybrid mode.

When the regenerative braking is performed in the fuel cell only mode, the relay is immediately turned on and, when the output power is reduced and thus the fuel cell voltage and the supercapacitor voltage become equal to each other, the relay is turned on to directly connect the fuel cell and the supercapacitor.

When the vehicle is accelerated while the output power is reduced, the relay is turned off at time point C1. In this case, the acceleration is performed while the supercapacitor is not sufficiently charged, and thus it is clear that the supercapacitor energy for the power assist is small.

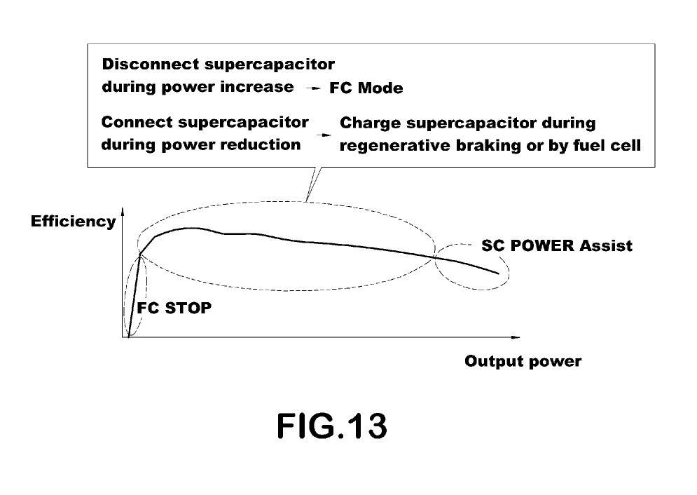

The above-described driving modes of the present invention such as the normal hybrid mode, the fuel cell only mode, the supercapacitor power assist mode, and the like will now be summarized with reference to FIG. 13 showing the change in output power of the fuel cell. The vehicle is driven in the fuel cell stop mode during the low power period and driven in the supercapacitor power assist mode during the high power period. Moreover, the vehicle is driven in the fuel cell only mode by cutting off the supercapacitor when the output power is increased. Further, during regenerative braking or power reduction, the vehicle is driven in the normal hybrid mode in which the supercapacitor is charged for the power assist.

As described above, the present invention provides the following effects.

According to the present invention, when the discharge amount of the battery is greater than a predetermined level in the normal hybrid mode in which the fuel cell and the supercapacitor are directly connected to each other, the relay between the fuel cell and the supercapacitor is turned off such that the vehicle enters the fuel cell only mode, thus preventing an initial discharge of the supercapacitor. Moreover, during high speed and high power operation, the discharge of the supercapacitor is performed through the unidirectional buck converter to provide the supercapacitor power assist, thus significantly improving the power performance during acceleration and high speed operation while preserving the advantages of the fuel cell-supercapacitor hybrid system.

Moreover, since the supercapacitor and the fuel cell are directly connected to each other by the relay at all times except for the power assist period, it is not necessary to use any power conversion device such as DC-DC converter, thus eliminating power loss. Furthermore, it is possible to recover much more regenerative braking energy due to the high power characteristics of the supercapacitor.

In addition, it is possible to avoid the low efficiency operation by stopping the fuel cell power generation during power operation, thus increasing the fuel efficiency.

The invention has been described in detail with reference to preferred embodiments thereof. However, it will be appreciated by those skilled in the art that changes may be made in these embodiments without departing from the principles and spirit of the invention, the scope of which is defined in the appended claims and their equivalents.

What is claimed is:

1. A power distribution device for a hybrid vehicle including a fuel cell and a supercapacitor, the device comprising:
a relay mounted on a charge/discharge line between the fuel cell and the supercapacitor;
a unidirectional buck converter disposed between an output terminal of the supercapacitor and a bus terminal of the fuel cell and outputting supercapacitor energy to the bus terminal of the fuel cell only when power assist is required; and
a control means controlling the operation of the relay and the unidirectional buck converter.

2. The power distribution device of claim 1, wherein the control means comprises:
a power distribution controller receiving a brake on/off signal, an accelerator pedal signal, a bus terminal voltage, and a supercapacitor voltage and outputting a relay on/off command and a converter controller output command; and
a converter controller controlling a duty ratio of the unidirectional buck converter based on the output command of from the power distribution controller.

3. The power distribution device of claim 1, wherein the unidirectional buck converter is a buck type converter operated under conditions where the supercapacitor voltage is high and the fuel cell voltage is low and having a capacity corresponding to the power required for the supercapacitor power assist.

4. A power distribution method for a hybrid vehicle including a fuel cell and a supercapacitor, wherein power distribution between the fuel cell and the supercapacitor is performed through driving modes including a normal hybrid mode, in which the vehicle is driven while the fuel cell and the supercapacitor are directly connected to each other by a relay between the fuel cell and the supercapacitor, a fuel cell only mode, in which electric power is supplied only from the fuel cell when the relay is turned off, and a supercapacitor power assist mode, in which only supercapacitor energy is output through a unidirectional buck converter while the relay is being turned off when high power is required.

5. The power distribution method of claim 4, wherein the driving modes further include a fuel cell stop mode in which power generation of the fuel cell is stopped and the required power is output only from the supercapacitor during low power operation of the fuel cell.

6. The power distribution method of claim 4, wherein a transition from the normal hybrid mode to the fuel cell only mode is performed in such a manner that, if it is determined that the fuel cell output power is greater than a predetermined level and that the supercapacitor is self-discharged while the fuel cell and the supercapacitor are directly connected to each other by the relay, the relay between the fuel cell and the supercapacitor is immediately turned off such that the discharge of the supercapacitor energy is stopped.

7. The power distribution method of claim 4, wherein a transition from the fuel cell only mode to the supercapacitor power assist mode is performed in such a manner that, if a time point at which the unidirectional buck converter is operated is reached as the fuel cell voltage drops in the fuel cell only mode, or if high power is required, a duty ratio of the unidirectional buck converter is controlled to provide the required power.

8. The power distribution method of claim 7, wherein the unidirectional buck converter performs a duty control using a voltage difference between the fuel cell voltage (bus terminal voltage) and the supercapacitor voltage to provide the required power.

9. The power distribution method of claim 4, wherein a transition from the supercapacitor power assist mode to the normal hybrid mode is performed in such a manner that, if the fuel cell voltage and the supercapacitor voltage become equal to each other, a power assist current control of the unidirectional buck converter is stopped and the fuel cell and the supercapacitor are directly connected to each other by the relay.

10. The power distribution method of claim 4, wherein a transition from the fuel cell only mode to the normal hybrid mode is performed in such a manner that, if it is necessary to recover regenerative braking energy to the supercapacitor, the fuel cell and the supercapacitor are directly connected to each other again by the relay.

11. The power distribution method of claim 4, wherein when the vehicle request power is reduced in the supercapacitor power assist mode, the supercapacitor power assist mode is switched to the normal hybrid mode.

12. The power distribution method of claim 5, wherein the fuel cell stop mode is performed by stopping the supply of air to a cathode of a fuel cell stack or by stopping the supply of hydrogen to an anode of the fuel cell stack.

13. The power distribution method of claim 12, wherein if it is determined that the vehicle request power is increased in the fuel cell stop mode or if it is determined that the supercapacitor voltage drops to a predetermined level corresponding to a time point at which the fuel cell power generation is restarted, the fuel cell power generation is restarted such that the vehicle enters the normal hybrid mode.
